(19) United States
(12) Patent Application Publication
(10) Pub. No.: US 2024/0246395 A1
(43) Pub. Date: Jul. 25, 2024

(54) POWER UNIT STRUCTURE

(71) Applicant: HONDA MOTOR CO., LTD., Tokyo (JP)

(72) Inventors: Rei Mizuno, Tokyo (JP); Yoshitaka Nukada, Tokyo (JP); Kaito Yamada, Tokyo (JP)

(21) Appl. No.: 18/416,932

(22) Filed: Jan. 19, 2024

(30) Foreign Application Priority Data
Jan. 24, 2023 (JP) 2023-008658

(51) Int. Cl. B60H 1/32

(52) U.S. Cl. CPC B60H 1/3222

(57) ABSTRACT

A power unit structure includes a driving shaft of a driving source, and a driven shaft interlocked with the driving shaft, the structure of a power unit further includes an auxiliary machinery driven by receiving a rotational motion of an output shaft which is one of the driving shaft and the driven shaft, an auxiliary machinery input shaft disposed coaxially with the output shaft is connected to the auxiliary machinery, and a connecting portion configured to integrally rotatably connect the auxiliary machinery input shaft is formed integrally with the output shaft.

### CROSS-REFERENCE TO RELATED APPLICATION

Priority is claimed on Japanese Patent Application No. 2023-008658, filed Jan. 24, 2023, the content of which is incorporated herein by reference.

### BACKGROUND OF THE INVENTION

### Field of the Invention

The present invention relates to a power unit structure.

### Description of Related Art

In recent years, in order to ensure that more people have access to affordable, reliable, sustainable, and advanced energy, research and development has been underway to improve fuel consumption and contribute to energy efficiency.

For example, Japanese Unexamined Patent Application, First Publication No. 2017-96390 discloses a power unit including a balancer shaft (driven shaft) driven via a chain from a crankshaft (driving shaft) of an engine (driving source). A driven sprocket is fixed to an end portion of the balancer shaft by a coaxial bolt.

### SUMMARY OF THE INVENTION

Incidentally, in the technology related to improvement of fuel consumption, when a power transmission element is separately provided on a rotary shaft, in addition to component tolerances of the rotary shaft and power transmission elements, there is also an assembly tolerance between the two components, which may cause the power transmission element to be shaken when the rotary shaft is driven.

An aspect of the present application is provided to contribute to suppression of vibrations and energy loss when auxiliary machinery is driven, and efficiency of energy, in a structure of a power unit to which auxiliary machinery driven by output of a driving source is connected.

A first aspect of the present invention is a power unit (20) structure including a driving shaft (22) of a driving source (21), and a driven shaft (30) interlocked with the driving shaft (22), the structure of a power unit further includes an auxiliary machinery (36) driven by receiving a rotational motion of an output shaft (30A) which is one of the driving shaft (22) and the driven shaft (30), an auxiliary machinery input shaft (34) disposed coaxially with the output shaft (30A) is connected to the auxiliary machinery (36), and a connecting portion (30f) configured to integrally rotatably connect the auxiliary machinery input shaft (34) is formed integrally with the output shaft (30A).

According to the configuration, since the connecting portion of the spline shaft or the like configured to connect the output shaft on the side of the driving source and the auxiliary machinery input shaft on the side of the auxiliary machinery are formed integrally with the output shaft, compared to a configuration in which a separate connecting portion is fixed to an output shaft by a bolt or the like, assembly tolerances between the output shaft and the connecting portion can be reduced. For this reason, a relative position shift between an axial center of the output shaft and an axial center of the auxiliary machinery input shaft can be minimized, and vibrations of the entire power unit and energy loss generated in driving the auxiliary machinery can be minimized. As a result, it is possible to improve comfort of equipment equipped with the power unit and reduce energy consumption of the driving source.

According to a second aspect of the present invention, in the first aspect, an auxiliary machinery-side connecting portion (34f) corresponding to the connecting portion (30f) is formed integrally with the auxiliary machinery input shaft (34).

According to the configuration, since the auxiliary machinery-side connecting portion configured to connect the output shaft on the side of the driving source is formed integrally with the auxiliary machinery input shaft, compared to a configuration in which a bolt or the like having an auxiliary machinery-side connecting portion is fixed to an auxiliary machinery input shaft, occurrence of assembly tolerance between the auxiliary machinery input shaft and the auxiliary machinery-side connecting portion can be suppressed. For this reason, a relative position shift between the axial center of the output shaft and the axial center of the auxiliary machinery input shaft can be further minimized, and vibrations of the entire power unit and energy loss generated in driving the auxiliary machinery can be further minimized.

According to a third aspect of the present invention, in the second aspect, the connecting portion (30f) and the auxiliary machinery-side connecting portion (34f) are spline shafts (30f, 34f) identical to each other, and include an integrated collar member (35) having a spline hole that crosses and engages with the connecting portion (30f) and the auxiliary machinery-side connecting portion (34f).

According to the configuration, since the output shaft-side connecting portion and the auxiliary machinery-side connecting portion are connected via the integrated collar member, this structure facilitates coaxial arrangement of the output shaft and the auxiliary machinery input shaft. For this reason, a relative position shift between the axial center of the output shaft and an axial center of the auxiliary machinery input shaft can be further minimized, and vibrations of the entire power unit and energy loss generated in driving the auxiliary machinery can be further minimized.

According to a fourth aspect of the present invention, in any one of the first to third aspects, the power unit (20) is mounted on a vehicle (1), and the auxiliary machinery (36) is a compressor (36) used in an air-conditioner of the vehicle (1).

According to the configuration, vibrations and energy loss in the driving path of the compressor used in the air-conditioner of the vehicle can be minimized, and comfort of the vehicle can be improved while improving cooling performance of the air-conditioner.

According to a fifth aspect of the present invention, in any one of the first to fourth aspects, the driving source (21) is an internal combustion engine (21), the driven shaft (30) is a balancer shaft (30) configured to suppress vibrations of the driving source (21), and the balancer shaft (30) is used as the output shaft (30A).

According to the configuration, in addition to avoiding the configuration in which the connecting portion is provided on the crankshaft (driving shaft) of the internal combustion engine, vibrations caused by misalignment of the axial centers between the balancer shaft and the pulley shaft can be suppressed, and energy loss caused by driving the balancer shaft can be curbed as far as possible.

According to a sixth aspect of the present invention, in any one of the first to fifth aspects, the auxiliary machinery (36) includes a main body input shaft (36a) disposed on a shaft separate from the output shaft (30A), a transmission mechanism (40) that is provided between the output shaft (30A) and the auxiliary machinery (36) and that includes the auxiliary machinery input shaft (34) which is configured to transmit a rotational motion of the output shaft (30A) to the main body input shaft (36a), and the transmission mechanism (40) includes a driving member (41) fixed to the auxiliary machinery input shaft (34), a driven member (42) fixed to the main body input shaft (36a), and an endless member (44) wrapped around the driving member (41) and the driven member (42). According to the configuration, in the configuration in which the output shaft on the side of the driving source and the main body input shaft of the auxiliary machinery are disposed as separate shafts and the auxiliary machinery input shaft is driven via the transmission mechanism, vibrations due to misalignment of the axial centers of the output shaft on the side of the driving source and the auxiliary machinery input shaft of the transmission mechanism can be minimized to suppress vibrations of the power transmission system via the transmission mechanism.

According to the aspects of the present invention, in the structure of the power unit to which the auxiliary machinery driven by output of the driving source is connected, vibrations and energy loss upon driving of the auxiliary machinery can be suppressed.

### BRIEF DESCRIPTION OF THE DRAWINGS

FIG. 1 is a left side view of a vehicle of an embodiment according to the present invention.

FIG. 2 is a cross-sectional view along line II-II in FIG. 1.

FIG. 3 is a perspective view of a power unit of the vehicle.

FIG. 4 is a cross-sectional view along line IV-IV in FIG. 2.

FIG. 5 is a cross-sectional view corresponding to FIG. 4 showing a comparative example of the embodiment.

### DETAILED DESCRIPTION OF THE INVENTION

Hereinafter, an embodiment of the present invention will be described with reference to the accompanying drawings. Further, directions of forward, rearward, leftward, rightward, and the like in the following description are the same as those of a vehicle described below unless the context indicates otherwise. In addition, in appropriate places in the drawings used in the following description, an arrow FR indicates the forward direction of the vehicle, an arrow LH indicates the leftward direction of the vehicle, an arrow UP indicates the upward direction of the vehicle, and a line CL indicates a lateral center of the vehicle.

### <Vehicle>

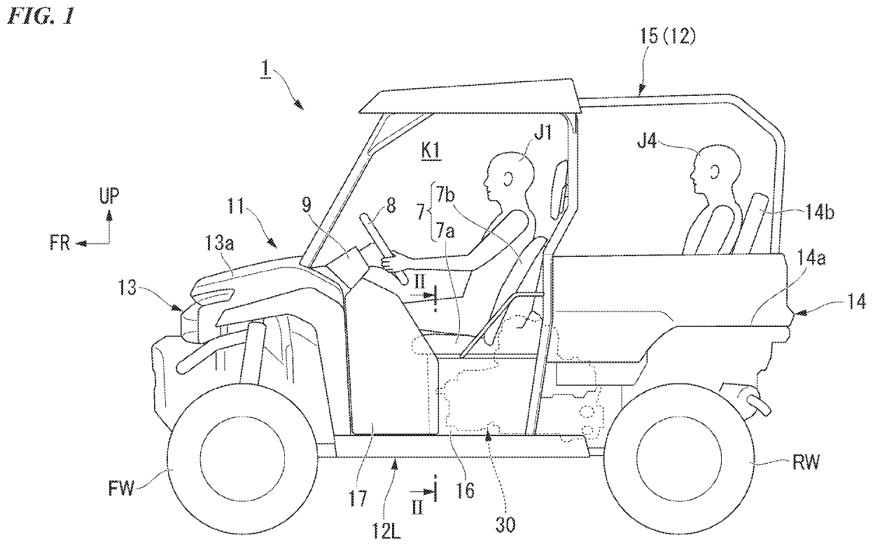

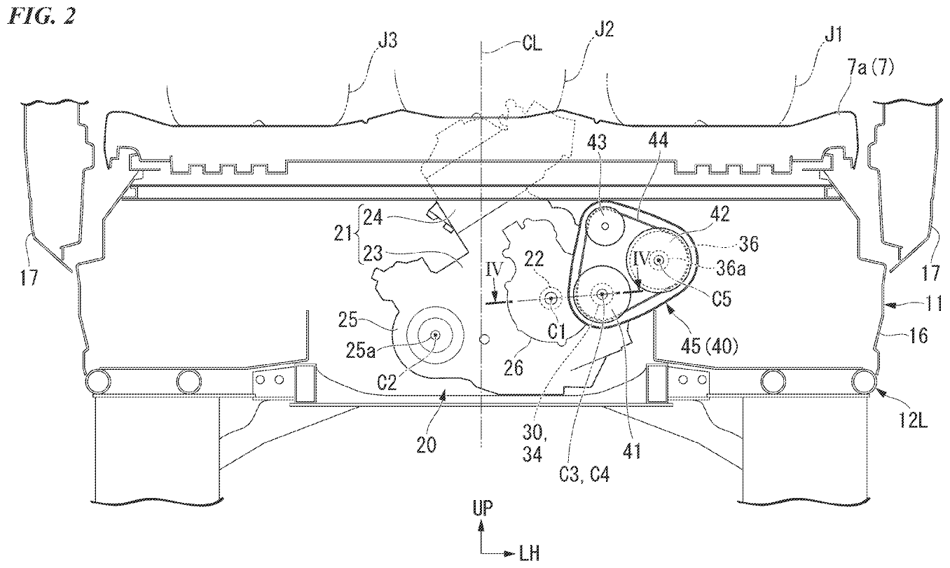

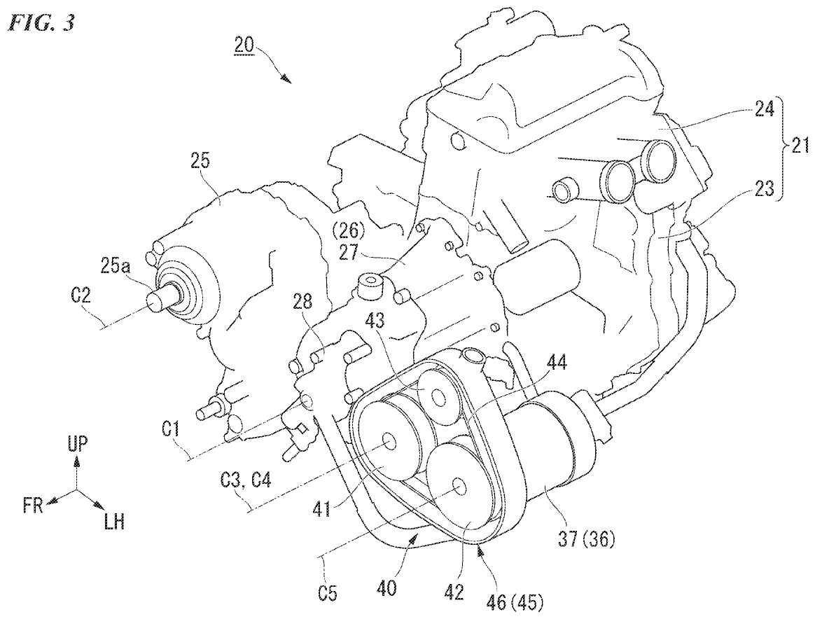

FIG. 1 is a left side view of a vehicle 1 of the embodiment. FIG. 2 is a cross-sectional view along line II-II in FIG. 1 (a cross-sectional view when a periphery of a power unit 20 is seen from a side in front of the vehicle). FIG. 3 is a perspective view of the power unit 20 of the embodiment.

Referring to FIG. 1 and FIG. 2, the vehicle 1 is a four-wheeled vehicle in which, for example, three people can ride side by side. Reference signs J1, J2 and J3 in the drawings indicate occupants arranged from a left side in sequence. The vehicle 1 is a so-called side-by-side type multi utility vehicle (MUV) whose main purpose is, for example, driving on rough terrain or the like. Further, the vehicle 1 is not limited to the MUV.

A vehicle body 11 of the vehicle 1 includes a cabin 12 in which an occupant rides. The vehicle body 11 includes a front body 13 provided in front of the cabin 12, a rear body 14 provided behind the cabin 12, and a lower body 12L provided below the cabin 12. The vehicle body 11 includes vehicle body frame (not shown) that crosses over the front body 13, the lower body 12L and the rear body 14.

A hood 13a is disposed above the front body 13. A cargo box 14a is disposed above the rear body 14. A rear seat 14b is disposed in the cargo box 14a to enable an occupant J4 to get on the rear seat. The lower body 12L constitutes a frame of a lower portion of the cabin 12. A frame of an upper portion of the cabin 12 is constituted by a roll bar assembly (hereinafter, simply referred to as a roll bar) 15. The upper portion of the cabin 12 has a boarding space K1 defined by the roll bar 15 assembled in a frame shape.

A seat 7 having a seat body (seat cushion) 7a and a backrest (seatback) 7b is disposed in the boarding space K1. For example, each of the seat body 7a and the backrest 7b is integrally formed across seating positions for three people in a vehicle width direction. In the embodiment, a left seat in the vehicle width direction is a seat for a driver J1, and center and right seats in the vehicle width direction are seats for occupants J2 and J3. A dashboard 9 is disposed with a foot space in front of the seat 7. A steering wheel 8 is disposed on one side of the dashboard 9 in a leftward/rightward direction (a left side in the embodiment). Reference sign 16 in the drawings designates a seat undercover configured to cover a space below the seat 7, and reference sign 17 designates a side door configured to open and close a side portion of the cabin 12.

Referring also to FIG. 3, the power unit 20 for vehicle traveling is mounted on the lower body 12L. The power unit 20 is disposed to cross a front portion of the rear body 14 from below the seat 7. The power unit 20 is disposed to overlap the vehicle lateral center CL.

The power unit 20 includes an engine (internal combustion engine) 21 that is a driving source. The engine 21 is a so-called vertical installation type in which an axial direction of a crankshaft 22 is a vehicle forward/rearward direction. Reference sign C1 in the drawings designates a rotational center axis of the crankshaft 22.

The engine 21 has a cylinder 24 erected on a crank case 23. For example, the engine 21 has a plurality of cylinders arranged in the vehicle forward/rearward direction. A gearbox (not shown) is accommodated in the crank case 23 on one side in the leftward/rightward direction of the vehicle (in the embodiment, a right side). A distribution mechanism 25 (transfer) is disposed on an output part of the gearbox. Front and rear output shafts 25a protrude from the front and the rear of the distribution mechanism 25. Reference sign C2 in the drawings designates a rotational center axis of the front and rear output shafts 25a.

The front and rear output shafts 25a are disposed on one side (right side) in the leftward/rightward direction of the vehicle, and the crankshaft 22 is disposed on the other side (left side) in the leftward/rightward direction of the vehicle. Output of the power unit 20 is appropriately transmitted to left and right front wheels FW and left and right rear wheels RW via a propeller shaft, a differential mechanism, and the like, from the front and rear output shafts 25a.

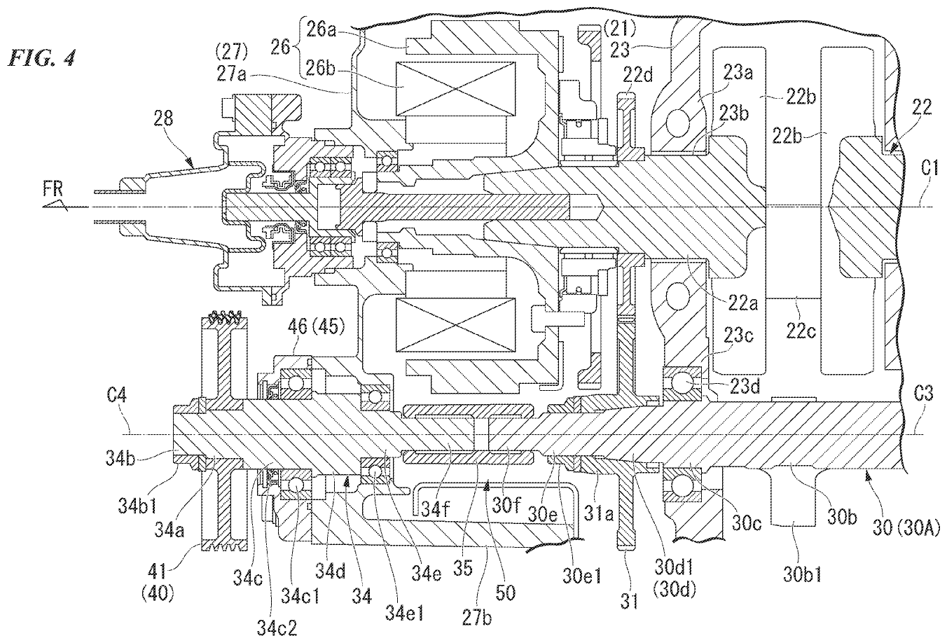

Referring to FIG. 3 and FIG. 4, a generator (auxiliary machinery, alternating current generator (ACG)) 26 is disposed on an end portion of the engine 21 on one side in an axial direction of the crankshaft 22 (a front end portion in the embodiment). The generator 26 includes a generator case 27 fixed to the crank case 23, a stator 26b fixed into the generator case 27, and a rotor 26a disposed inside the stator 26b coaxially with the crankshaft 22. The rotor 26a is rotated and operated integrally with the crankshaft 22. An aspect of the operation of the generator 26 is controlled by a control device (not shown). The generator 26 not only generates electricity in conjunction with the operation of the engine 21, but also may generate assistance torque to assist in driving the engine 21, or may be used as a starter motor.

A water pump 28 of a cooling device of the engine 21 is disposed on one side (front side) of the generator 26 in the axial direction. The water pump 28 includes a pump housing fixed to the generator case 27, and a pump rotor disposed inside the pump housing coaxially with the crankshaft 22. The pump rotor is rotated and operated integrally with the crankshaft 22. Reference sign 23a in the drawings designates a crankshaft support portion configured to support the crankshaft 22 in the crank case 23, reference sign 22a designates a journal part supported by the crankshaft support portion 23a in the crankshaft 22 via a metal (slide bearing) 23b, and reference sign 22b designates a pair of crank webs (crank arms) configured to support a crank pin 22c in the crankshaft 22.

The generator case 27 forms an appearance of the generator 26. The generator case 27 includes a bottomed cylindrical case main body portion 27a coaxial with the generator 26, and an overhanging portion 27b overhanging leftward from the case main body portion 27a in the forward/rearward direction. The rotor 26a and the stator 26b in the generator case 27 are accommodated inside the case main body portion 27a. The overhanging portion 27b is disposed in front of a balancer shaft 30 (driven shaft), which will be described below.

The balancer shaft 30 is accommodated inside the crank case 23 on the other side of the vehicle in the leftward/forward direction (in the embodiment, a left side, a side opposite to the gearbox). The balancer shaft 30 is arranged in the axial direction parallel to the crankshaft 22. Reference sign C3 in the drawings designates a rotational center axis of the balancer shaft 30, reference sign 22d designates a balancer drive gear fixed to the crankshaft 22, and reference sign 31 designates a balancer driven gear 31 fixed to the balancer shaft 30.

The balancer drive gear 22d and the balancer driven gear 31 are facing gears with the same diameter. The balancer shaft 30 rotates at the same speed as the crankshaft 22. An end portion (front end portion) of the balancer shaft 30 on one side in the axial direction is disposed in the overhanging portion 27b of the generator case 27. The balancer shaft 30 is an example of an output shaft 30A configured to output a driving force of an auxiliary machinery (a compressor 36 for an air-conditioner), which will be described below.

A pulley shaft 34 (auxiliary machinery input shaft) is disposed coaxially in front of the front end portion of the balancer shaft 30. Reference sign C4 in the drawings designates a rotational center axis of the pulley shaft 34. The pulley shaft 34 is a shaft configured to support a drive pulley 41 (driving member) of a transmission mechanism 40. The drive pulley 41 is integrally rotatably connected to the balancer shaft 30 via the pulley shaft 34 and a connecting structure 50, which will be described below. The transmission mechanism 40 including the drive pulley 41 is interlocked with the crankshaft 22 to rotate and operate the compressor 36.

The transmission mechanism 40 includes the drive pulley 41, a driven pulley 42 (driven member), a tensioner pulley 43, a transmission belt 44 (endless member), and a pulley case 45.

The pulley case 45 includes a pulley base 46 and a pulley cover (not shown). For convenience of illustration, the pulley cover is not shown. The pulley base 46 has a right side portion fixed to the overhanging portion 27b of the generator case 27. The pulley base 46 is a support member configured to support a front end portion of the compressor 36 on the generator case 27. A front end opening of the pulley base 46 is covered with the pulley cover from the front.

The drive pulley 41 and the driven pulley 42 have substantially the same diameter, and are arranged laterally in the forward/rearward direction (axial direction). The tensioner pulley 43 is disposed separately above a lateral intermediate portion of the drive pulley 41 and the driven pulley 42 when seen in the forward/rearward direction. The endless transmission belt 44 is wound to surround these pulleys from an outer circumferential side. The pulley case 45 that accommodates each pulley is formed in a triangular shape that follows a trajectory of the transmission belt 44 when seen in the forward/rearward direction.

A left side portion of the pulley case 45 overhangs further leftward from the overhanging portion 27b of the generator case 27 when seen in the forward/rearward direction. The compressor 36 is disposed behind a left side portion of the pulley case 45. The compressor 36 has a rotary shaft 36a (main body input shaft) (see FIG. 2) parallel to the crankshaft 22 and the balancer shaft 30 in the axial direction. Reference sign C5 in the drawings designates a rotational center axis of the rotary shaft 36a of the compressor 36 in the drawings.

The compressor 36 is disposed behind the left side portion of the pulley case 45. The compressor 36 is disposed coaxially with the driven pulley 42 of the transmission mechanism 40. The compressor 36 is driven by rotational moving power transmitted to the driven pulley 42. The compressor 36 is disposed to be arranged on a left side of the generator 26. With this arrangement, compared to a configuration in which the compressor 36 is coaxially disposed in front of and connected to the balancer shaft 30, an increase in size of the power unit 20 in the axial direction can be suppressed.

The compressor 36 has a bottomed cylindrical compressor case 37 that forms the appearance thereof. The compressor case 37 has a front end portion fixed to the left side portion of the pulley base 46. While the compressor case 37 and the pulley base 46 are separated from each other in the embodiment, they may be configured integrally with each other.

The balancer drive gear 22d is supported in front of the crankshaft support portion 23a on the front side. A balancer shaft support portion 23c is disposed on a left side of the crankshaft support portion 23a so as to overlap the crankshaft support portion 23a at a position in the axial direction. The balancer driven gear 31 is supported in front of the balancer shaft support portion 23c. The balancer driven gear 31 meshes with the balancer drive gear 22d. The crankshaft 22 drives the balancer shaft 30 via the balancer drive gear 22d and the balancer driven gear 31.

The balancer shaft 30 includes a weight support portion 30b configured to support a balancer weight 30b1, a journal part 30c continuous with the front of the weight support portion 30b and supported by the balancer shaft support portion 23c via a ball bearing 23d, a gear support portion 30d continuous with the front of the journal part 30c and includes a tapered portion 30d1, a screw shaft 30e continuous with the front of the gear support portion 30d and onto which a gear fixing nut 30el is screwed, and a spline shaft 30f (connecting portion) continuous with the front of the screw shaft 30e and configured to connect the pulley shaft 34.

The gear fixing nut 30el tightens a collar portion 31a formed on a center portion of the balancer driven gear 31 toward the tapered portion 30dl of the gear support portion 30d. The balancer shaft 30 is an integrated component with a plurality of shaft portions formed from the same member.

The pulley shaft 34 includes a pulley support portion 34a disposed in front of the generator 26 in the axial direction and configured to support the drive pulley 41, a screw shaft 34b continuous with the front of the pulley support portion 34a and onto which a pulley fixing nut 34b1 is screwed, a first shaft 34c continuous with the rear of the pulley support portion 34a, supported by the cover of the pulley case 45 via a ball bearing 34cl and with which a seal member 34c2 becomes in sliding contact, a second shaft 34d continuous with the rear of the first shaft 34c and having a diameter larger than that of the first shaft 34c, a third shaft 34e continuous with the rear of the second shaft 34d, supported by the overhanging portion 27b of the generator case 27 via a ball bearing 34el and having a diameter smaller than that of the first shaft 34c, and a pulley-side spline shaft 34f (auxiliary machinery-side connecting portion) continuous with the front of the third shaft 34e and facing the spline shaft 30f of the balancer shaft 30 in the axial direction.

A front end portion of the spline shaft 30f of the balancer shaft 30 and a rear end portion of the pulley-side spline shaft 34f face each other at an interval in the axial direction. The pulley shaft 34 is an integrated component with a plurality of shaft portions formed from the same member. For example, the pulley-side spline shaft 34f is longer than the spline shaft 30f of the balancer shaft 30 in the axial direction.

The spline shaft 30f of the balancer shaft 30 and the pulley-side spline shaft 34f of the pulley shaft 34 are disposed so as to overlap the generator 26 at a position in the axial direction. The spline shafts 30f and 34f are spline shafts having the same shape and the same size. A cylindrical collar member 35 is mounted to bridge both the spline shafts 30f and 34f. Spline holes corresponding to both the spline shafts 30f and 34f are formed in the inner circumferential portion of the collar member 35. Both the spline shafts 30f and 34f are connected to be rotated integrally with the pulley shaft 34 and the balancer shaft 30 via the collar member 35.

The collar member 35 and both the spline shafts 30f and 34f constitute the connecting structure 50 that connect the pulley shaft 34 and the balancer shaft 30 to be rotatable integrally. The connecting structure 50 increases a degree of freedom in the assembly procedure of the compressor 36 and the transmission mechanism 40, making it easier to assemble the power unit 20.

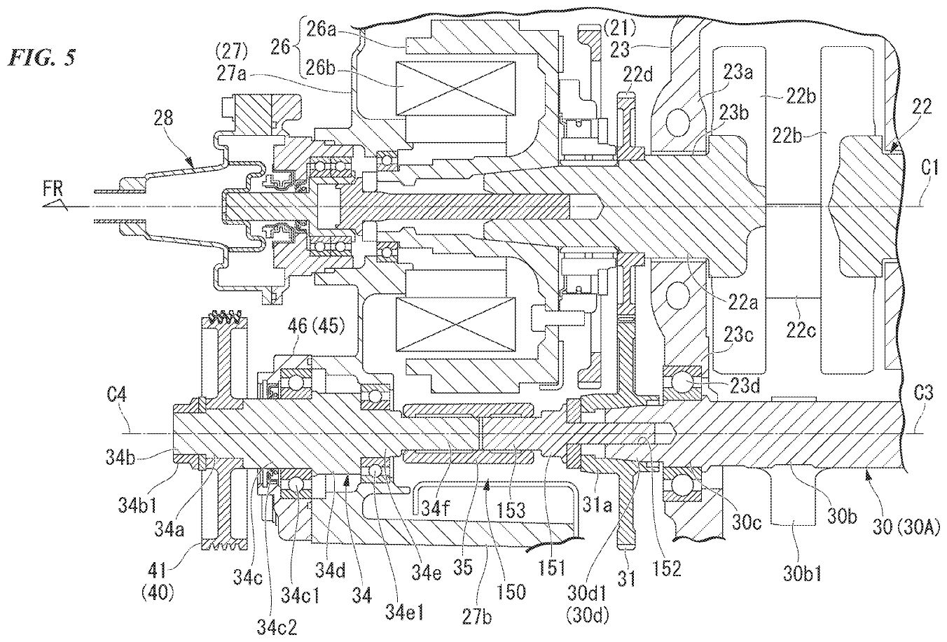

FIG. 5 shows a connecting structure 150 of a comparative example with respect to the embodiment. In the connecting structure 150 of the comparative example, a spline shaft of the balancer shaft 30 is constituted by a member separated from the balancer shaft 30. In the comparative example, the collar portion 31a of the balancer driven gear 31 is fastened to the front end portion of the balancer shaft 30 by a bolt 151 other than a nut 30el. According to this, the front end portion of the balancer shaft 30 does not have the screw shaft 30e and the spline shaft 30f of the embodiment, and instead has a screw hole 152 formed therein. A spline shaft 153 extending rearward from a head portion is formed integrally with the bolt 151.

In such a configuration, since the balancer shaft 30 and the spline shaft 153 are separate bodies, there is an assembly tolerance between the two components in addition to the individual component tolerance of both components. For this reason, there is a possibility that the axial center of the spline shaft 153 may be misaligned or tilted. When the axial center of the spline shaft 153 is misaligned or tilted, shakes will occur in the drive pulley 41 when the compressor 36 is driven, leading to vibrations or energy loss of the entire power unit 20.

On the other hand, in the configuration of the embodiment, since the balancer shaft 30 and the spline shaft 30f are integrally formed of a single material, misalignment or the like of the axial center of the spline shaft 30f is suppressed as much as possible, and occurrence of the vibrations or energy loss of the entire power unit 20 is minimized.

As described above, in the structure of the power unit 20 including the driving shaft (the crankshaft 22) of the driving source (the engine 21) and the driven shaft (the balancer shaft 30) interlocked with the driving shaft, the power unit structure according to the embodiment includes the auxiliary machinery (the compressor 36) driven by receiving a rotational motion of the output shaft 30A which is the balancer shaft 30 as the output shaft 30A, the auxiliary machinery input shaft (the pulley shaft 34) disposed coaxially with the output shaft 30A is connected to the compressor 36, and the connecting portion (the spline shaft 30f) configured to integrally rotatably connect the pulley shaft 34 is formed integrally with the output shaft 30A.

According to the configuration, since the connecting portion such as the spline shaft 30f or the like configured to connect the output shaft 30A on the side of the engine 21 and the pulley shaft 34 on the side of the compressor 36 is formed integrally with the output shaft 30A, compared to the configuration in which the bolt or the like having the connecting portion is fixed to the output shaft 30A, occurrence of the assembly tolerance between the output shaft 30A and the connecting portion can be minimized. For this reason, a relative position shift between the axial center of the output shaft 30A and the axial center of the pulley shaft 34 can be suppressed, and vibrations of the entire power unit 20 and energy loss occurred in driving the compressor 36 can be suppressed. As a result, the comfort of equipment equipped with the power unit 20 can be improved, and the energy consumption of the engine 21 can be reduced.

“Integral formation” in the embodiment means that it is formed integrally from a single material or multiple materials by molding, machining, or the like.

In the power unit structure, the auxiliary machinery-side connecting portion (the pulley-side spline shaft 34f) corresponding to the spline shaft 30f is formed integrally with the pulley shaft 34.

According to the configuration, since the pulley-side spline shaft 34f configured to connect the output shaft 30A on the side of the engine 21 is formed integrally with the pulley shaft 34, compared to the configuration in which the bolt or the like having the pulley-side spline shaft 34f is fixed to the pulley shaft 34, occurrence of the assembly tolerance between the pulley shaft 34 and the pulley-side spline shaft 34f can be minimized. For this reason, the relative position shift between the axial center of the output shaft 30A and the axial center of the pulley shaft 34 can be minimized, and vibrations of the entire the power unit 20 and energy loss generated in driving the compressor 36 can be further minimized.

In the power unit structure, the spline shaft 30f and the pulley-side spline shaft 34f are mutually identical spline shaft, and include the integrated collar member 35 having a spline hole that bridges and engages the spline shaft 30f and the pulley-side spline shaft 34f.

According to the configuration, since the spline shaft 30f on the side of the output shaft 30A and the pulley-side spline shaft 34f are connected via the integrated collar member 35, it is easy to dispose the output shaft 30A and the pulley shaft 34 coaxially. For this reason, the relative position shift between the axial center of the output shaft 30A and the axial center of the pulley shaft 34 can be further minimized, and vibrations of the entire the power unit 20 and energy loss generated in driving the compressor 36 can be further minimized.

In the power unit structure, the power unit 20 is mounted on the vehicle 1, and the auxiliary machinery is the compressor 36 used in an air-conditioner of the vehicle 1. According to the configuration, vibrations and energy loss in the driving path of the compressor 36 used in the air-conditioner of the vehicle 1 can be minimized, and comfort of the vehicle 1 can be improved while improving cooling performance of the air-conditioner.

In the power unit structure, the balancer shaft 30 of the engine 21 is used as the output shaft 30A.

According to the configuration, in addition to avoiding the configuration in which the connecting portion is provided on the crankshaft 22 (driving shaft) of the engine 21, vibrations caused by misalignment of the axial centers between the balancer shaft 30 and the pulley shaft 34 can be suppressed, and energy loss caused by driving the balancer shaft 30 can be suppressed as much as possible.

In the power unit structure, the compressor 36 includes the main body input shaft (the rotary shaft 36a) disposed on a shaft separate from the output shaft 30A, the transmission mechanism 40 that is provided between the output shaft 30A and the compressor 36 and that includes the pulley shaft 34 which is configured to transmit a rotational motion of the output shaft 30A to the rotary shaft 36a, and the transmission mechanism 40 includes the driving member (the drive pulley 41) fixed to the pulley shaft 34, the driven member (the driven pulley 42) fixed to the main body input shaft, and the endless member (the transmission belt 44) wrapped around the driving member and the driven member.

According to the configuration, in the configuration in which the output shaft 30A on the side of the engine 21 and the rotary shaft 36a of the compressor 36 are disposed on the separate shafts and the rotary shaft 36a is driven via the transmission mechanism 40, vibrations of the power transmission system via the transmission mechanism 40 can be minimized by suppressing vibrations due to misalignment by the axial centers of the output shaft 30A on the side of the engine 21 and the pulley shaft 34 of the transmission mechanism 40.

Further, the present invention is not limited to the embodiment, and for example, the driving source of the power unit is not limited to the engine (internal combustion engine) but may be an electric motor. In addition, the driving source may include at least one of the internal combustion engine and the electric motor.

The configuration is not limited to a configuration in which the driven shaft (the balancer shaft 30) is used as an output shaft to drive the auxiliary machinery, but a configuration in which the driving shaft (the crankshaft 22) is used as the output shaft to drive the auxiliary machinery is also possible. That is, any configuration is acceptable as long as one of the driving shaft and the driven shaft is used as an output shaft to drive the auxiliary machinery.

The driven shaft is not limited to the balancer shaft 30 but may be a transmission shaft of the gearbox, a cam shaft of a valve gear, or the like.

The auxiliary machinery is not limited to the compressor 36 for an air-conditioner, but for example, may be various types of oil pumps, cooling devices, electric motors, or the like.

The configuration is not limited to the configuration in which the output shaft and the auxiliary machinery are connected in parallel but may be a configuration in which the output shaft and the auxiliary machinery are connected in series.

The connecting portion is not limited to the spline shaft but may be a spline hole, and further, may be a key, a key groove, a rectangular column, a rectangular hole, or the like.

For example, the present invention is not limited to application to vehicles with four wheels, but may also be applied to vehicles with two or three wheels (including vehicles with one front wheel and two rear wheels, as well as vehicles with two front wheels and one rear wheel).

The present invention is not limited to application to vehicles, but may also be applied to various vehicles and moving objects, for example, various types of transportation equipment such as aircrafts and ships, as well as construction machinery and industrial machinery. Further, the present invention can be widely applied to equipment other than vehicles (for example, hand-powered lawn mowers, cleaning machines, or the like).

While preferred embodiments of the invention have been described and illustrated above, it should be understood that these are exemplary of the invention and are not to be considered as limiting. Additions, omissions, substitutions, and other modifications can be made without departing from the spirit of the present invention. Accordingly, the invention is not to be considered as being limited by the foregoing description, and is only limited by the scope of the appended claims.

What is claimed is:

1. A structure of a power unit comprising:
a driving shaft of a driving source; and
a driven shaft interlocked with the driving shaft,
the structure of a power unit further includes an auxiliary machinery driven by receiving a rotational motion of an output shaft which is one of the driving shaft and the driven shaft,
an auxiliary machinery input shaft disposed coaxially with the output shaft is connected to the auxiliary machinery, and
a connecting portion configured to integrally rotatably connect the auxiliary machinery input shaft is formed integrally with the output shaft.

2. The power unit structure according to claim 1, wherein an auxiliary machinery-side connecting portion corresponding to the connecting portion is formed integrally with the auxiliary machinery input shaft.

3. The power unit structure according to claim 2, wherein the connecting portion and the auxiliary machinery-side connecting portion are spline shafts identical to each other, and
include an integrated collar member having a spline hole that crosses and engages with the connecting portion and the auxiliary machinery-side connecting portion.

4. The power unit structure according to claim 1, wherein the power unit is mounted on a vehicle, and
the auxiliary machinery is a compressor used in an air-conditioner of the vehicle.

5. The power unit structure according to claim 1, wherein the driving source is an internal combustion engine,
the driven shaft is a balancer shaft configured to suppress vibrations of the driving source, and
the balancer shaft is used as the output shaft,

6. The power unit structure according to claim 1, wherein the auxiliary machinery includes a main body input shaft disposed on a shaft separate from the output shaft,
a transmission mechanism that is provided between the output shaft and the auxiliary machinery and that includes the auxiliary machinery input shaft which is configured to transmit a rotational motion of the output shaft to the main body input shaft, and
the transmission mechanism includes a driving member fixed to the auxiliary machinery input shaft, a driven member fixed to the main body input shaft, and an endless member wrapped around the driving member and the driven member.
